(19) United States
(12) Patent Application Publication
(10) Pub. No.: US 2017/0069013 A1
(43) Pub. Date: Mar. 9, 2017

(54) METHOD FOR PROVIDING PERSONAL SHOPPING SERVICES USING MOBILE COMMUNICATION DEVICE APPLICATIONS

(71) Applicant: Alexander Chase Castillo, Galveston, TX (US)

(72) Inventor: Alexander Chase Castillo, Galveston, TX (US)

(21) Appl. No.: 14/844,238

(22) Filed: Sep. 3, 2015

(51) Int. Cl. G06Q 30/06; H04W 4/02; G06Q 10/10; H04L 12/58; G06Q 30/08; G06Q 50/00; H04W 88/02; H04L 29/08

(52) U.S. Cl. CPC G06Q 30/0635; H04W 88/02; H04W 4/021; H04L 67/306; H04L 51/046; H04L 51/32; H04L 51/38; G06Q 30/08; G06Q 50/01; G06Q 10/1097

(57) ABSTRACT

A method for providing personal shopping services using mobile communication device applications to coordinate the acquisition and delivery of goods utilizing mobile communications, interactive device applications, point to multipoint routing, predictive analytics and positioning technology to facilitate integrated advertising, ordering, payment, personal shopping and delivery of goods to persons and businesses based on proximity, time of day and patterns of behavior.

### CROSS-REFERENCE TO RELATED APPLICATION 35 USC §119(e)

Not Applicable

### FIELD OF INVENTION

This invention relates to methods for providing personal shopping services either originated by a person or business desiring the services of a third party to acquire and deliver goods to the requestor; or, a merchant desiring to enhance the customer experience by providing the value added services such as of point to multipoint, multipoint to point or multipoint to multipoint delivery for convenience, satisfaction and customer retention. The merchant benefits include new advertising channels, predictable sales and potential profit improvement. This invention also relates to third party delivery service coordination based on proximity and scheduled routines developed through predictive analytics and personal behaviors.

### BACKGROUND OF INVENTION

In the mid-1990s, the internet started a revolutionary impact on culture as well as commerce. This included innovations throughout many fields such as electronic mail, instant messaging, global positioning system technology as well as online shopping. The use of the internet has continued to grow since this time and most recently is responsible for communicating more than 97%, estimated, of telecommunication information as of 2007.

Around 2001, the internet began to show its value in the mobile phone industry. Since then, an increasing number of users began accessing the internet through phone rather than the personal computer. In 2008, internet access was largely accessed through mobile phones or wireless devices versus tethered cable personal computers and this seems to be the continued trajectory of growth for the present as well as the near future.

As the number of users accessing the internet via mobile phone increased the applications of mobile software programs increased as well. Throughout the 1990's and 2000's, instant messaging became popular in the computer industry as can be seen with AOL® instant messaging and Twitter®. Instant messaging is the real-time text transmissions over the internet allowing for one user to communicate with another user despite distance between the users communicating. This technology has remained valuable as society transitioned into the mobile phone dominated era. Instant messaging has allowed for users to communicate instantaneously. As such, the present embodiment known as Requestky™ combines in-app instant messaging to allow requestors and personal shoppers to communicate in regards to the acquisition and transportation of goods, to clear up any questions of the order or where to drop off goods acquired for the benefit of the requestor.

Mobile phone technology began using GPS technology for many applications such as mapping and connecting local peers. Google® maps began using this technology in their innovative Google® Maps Navigation. This technology is used to navigate users to a place of interest while able to provide them with information such as: miles to destination, estimated time to arrival (ETA) and points of interest along the way. As this technology got even more advanced, the software was able to identify areas of increased traffic delay and reflect the delay in ETA accordingly. Uber® LLC recently improvised this technology and demonstrated the application of connecting two independent users based on their current respective locations. The present embodiment will also use GPS to identify and connect a personal shopper user who can pick up a good for a separate requestor user who is able to pay for his service. GPS will be used to demonstrate the pick-up location, the drop-off location, as well as a real-time tracking of the order in transit.

As online shopping and commerce increased on the internet there has been a drive for improvement of online payment methods. Paypal® was established in 1998 to provide a worldwide online payment system. Paypal® is now a dominating player in the internet online payment industry. As the internet transitioned to the mobile phone era, Paypal® acquired the company Braintree® to further production and development in the mobile payment services. The present embodiment envisions utilizing the payment model and services of Braintree® to process payments.

In US 20140052562 A1, System and method for interactive and social shopping, a method is described for providing assistance to a consumer comprising: authenticating with a shopping service over a network using a network adapter; downloading a shopping list from the shopping service over the network using the adapter; displaying the shopping list to the user on a display screen, the shopping list comprising a name of an item, wherein each item in the hopping list is displayed as a tile, wherein each tile is arranged in a series of rows and columns; receiving an input identifying one or more changes to the shopping list; processing the input using a computer processor; and sending the one or more changes to the shopping service over the network using the network adapter. The present embodiment addresses the limitations inherent in such shopping list approaches.

In US 20120225671 A1, Method for requesting transportation services is described, comprising: providing a wireless communications network for routing messages; providing a computer for processing information in cooperation with the wireless communications network; sending a request for transportation services to the computer through the communications network using a first communications device having a fixed geographic location; sending the geographic location of the first communications device to the computer through the wireless communications network; storing the request and the determined location on the computer; transmitting the store cation of the first communications device to at least one transportation provider having a wireless mobile communications device through the wireless communications network; generating a first confirmation signal on the wireless communications network from the at least one transportation provider; selecting one transportation provider from the at least one transportation provider using the computer on the basis of at least one chosen criterion; and generating a second confirmation signal from the computer to the transportation requester using the wireless communications network notifying the transportation requester that transportation service has been arranged. The present embodiment address the limitations of location based selection and introducing techniques for broadcasting to the community of users.

US 20140129951 A1 describes a method for requesting an on-demand service on a computing device. One or more processors determine the current location of the computing device. A multistate selection feature of a plurality of service options for providing the on-demand service is presented on the display of the computing device. The multistate selection feature enables a user to select a service option that is available within a region that includes the current location to provide the on-demand service. In response to the user selecting one of the plurality of service options, a summary user interface is presented on the display to provide region-specific information about the on-demand service based on the selected service option. The present embodiment address the limitations of finite service options with open ended needs based requests.

US 20140129302 A1 describes a method for providing transport services is provided. A transport request for a transport service is received from a user. The transport request specifies at least one of a pickup or drop-off location. A confirmation panel is generated to display information corresponding to the at least one of the pickup location or drop-off location. On the confirmation panel, a map relevant to the at least one of the pickup location or drop-off location is displayed. Fare information relevant to the transport request is also displayed on the confirmation panel. A prompt is provided for the user to confirm the transport request. The present embodiment addresses the limitations inherent in fixed pricing by introducing variable pricing and multipoint to point or multipoint opportunities to stimulate greater efficiency and economic viability to all users.

US 20140129135 describes a system and method for providing position information of a transit object to a computing device. Global positioning satellite (GPS) information of a transit object can be periodically received. For each of some of the GPS information, one or more candidate points of a transit system can be identified based on the GPS information. Using the one or more candidate points, a most likely path of travel can be determined. Additional position points along the most likely path of travel can be extrapolated and transmitted to a computing device. The present embodiment address the limitations of GPS only routing to incorporate techniques of least cost routing to improve the economic viability for users.

US 20130246301 A1 describes a system and method for providing feedback for a transportation service. A rating user interface can be provided after completion of a service. In response to a user's providing a rating for the transportation service, additional rating features can be provided as part of the rating user interface. If the rating is equal to or higher than a predetermined level, the user may be enabled to share positive aspects of the service with other people. If the rating is below the predetermined level, the user may be enabled to indicate categories which the user was dissatisfied with. The present embodiment address the limitations inherent with single perspective rating systems by introducing techniques for bi-directional peer to provider rating options.

In US 20130246207 a method for adjusting prices for services is provided. One or more processors make a determination of an amount of requesters for a service at a given time and an amount of available service providers for providing the service at the given time. A price, relative to a default price, for using the service provided by one or more service providers is adjusted based on the determined amount of requesters and the determined amount of available service providers. Pricing data corresponding to the adjusted price is transmitted to one or more requesting devices or one or more provider devices so that the adjusted price can be displayed on at least one of the one or more requesting devices or the one or more provider devices and be indicative of an adjustment in price as compared to the default price. The present embodiment address the limitations inherent in adjustable prices by introducing priority selection and reserved disclosure distribution to only qualified personal shoppers.

In US 20130132887 A1 a method for operating a computing device is disclosed. A user interface of an application that is running on the computing device is displayed. The user interface has a first panel and a second panel in an original position. The computing device can receive a user input. In response to receiving the user input, the first panel and the second panel can be transitioned to display a set of features that were not previously displayed before receiving the user input. The present embodiment address limitations associated with static displays by introducing direct peer to peer communications between users.

In US 20130132246 A1 a method for providing a service summary or receipt on a computing device is provided. One or more processors determine information for a service rendered for a user. The information includes a cost for the service, a type of service performed, and a person who performed the service. A summary receipt panel is provided on a display of the computing device and includes the information for the service rendered. The one or more processors provide, on the summary receipt panel, a map that identifies a location relevant to the service rendered and a feedback feature that enables the user to rate the service received. The present embodiment address limitations of formulated receipts by introducing visual imaging receipts to provide authentication and verification transparency between users.

US 20130132140 A1 a method for determining a location relating to an on-demand service on a computing device is provided. One or more processors receiving a transport request from a user. The transport request specifies at least one of a pick-up region or a drop-off region. One or more locations of interests within the at least one of the pick-up region or the drop-off region are determined. Based on the at least one of the pick-up region or the drop-off region, one or more historical locations related to the user is determined. A likely location is determined based on the determined one or more locations of interest and the one or more historical locations. The present embodiment address the limitations with regional proximity selection by introducing selection based on content task content which provides flexibility in the location for fulfillment.

Although there are several apparatuses which may have various functions related to the Method for providing personal shopping services using mobile communication device applications, none of these either separately or in combination with each other, teach or anticipate the current invention. Therefore, there remains an unmet need in the field of providing personal shopping services either originated by a person or business desiring the services of a third party to acquire and deliver goods. The current invention will fulfill this unmet need.

### SUMMARY OF INVENTION

The following presents a simplified summary in order to provide a basic understanding of some aspects of the disclosed invention. This summary is not an extensive overview, and it is not intended to identify key/critical elements or to delineate the scope thereof. Its sole purpose is to present some concepts in a simplified form as a prelude to the more detailed description that is presented later.

The preferred embodiment is a method and associated process to order goods or services using the application without knowing the price ahead of time. This is achieved by using the phones camera and receipt for verification. Additionally, the preferred embodiment is an advertisement method and associated process of a proactive and individualized advertising event based on system generated predictions of what a user has time in their schedule for or generated suggestions to compliment an order such as a suggestion to add a beverage or meal during a suggested time; i.e., based off of their calendar. Also, the preferred embodiment an advertisement method and associated process in which to individualize responses and tailor advertising to an individual determined by association to good or service being delivered to their location or within a quantifiable proximity thereto.

The preferred embodiment presented herein includes features and functionality utilizing a probability gauge that allows the personal shopper to predict the probability of getting another order request near the drop off location by considering surrounding food vendors, merchants and other population determined through queries of historical information based on prior events occurring under similar circumstances in close proximity to the current event location. This probability gauge presented in this preferred embodiment provides additional functionality to predict the likelihood of a user's request to be accepted by considering their delivery fee offering, location pick up and drop off based upon historical information related to prior similar events.

The present embodiment manages a list of items to pick up (ex: a burger w/no tomatoes) that will be on a list sent to the personal shopper supported by an enhanced feature to facilitate direct communication between requestor and personal shopper for processing changes. Use behaviors will be recorded to simplify reordering.

The present embodiment also implements an embedded predictor gauge which will be used by personal shoppers to identify which orders will be the most beneficial to accept and deliver. This process is implemented within the method and associated processes to evaluate the pick-up location (busy area and possibility of getting another order there), drop off location (chance of getting another order in the drop off location) and competitiveness of pay. Although the personal shopper is multi-tasking, each specific requestor's list is managed and tracked individually.

The present embodiment implements scanning functions to identify and associate requestors and common interests based on pre-existing social relationships. Embedded processes will map users with similar interest (or “likes”) on social media even if they don't have pre-existing social relationships, which will allow for individual order advertisement. (i.e., someone in close proximity is ordering something for lunch and another user likes that restaurant that is nearby, automatically send prompt inviting the user to place order). When a user requests an good or service from a merchant the order will be forwarded to the personal shopper as well as the respective merchant. The merchant will prepare the item so that when the personal shopper arrives it will be ready for pick and delivery.

The present embodiment processes information using a consolidation process to organize order layout to determine which merchant location would be most optimal to stop at first. A requester will get notification once his order has been accepted and informed as to the identity of the personal shopper for this event. The present embodiment will use GPS functionality to allow users to continuously track the transit of their order.

The present embodiment provides for enhanced services such as on-demand service, confirmation notifications, real time event reporting and options to cancel orders. Confidentiality is provided for in the present embodiment through a process of incremental disclosure of identities, order details and pricing.

The present embodiment implements variable pricing functions and associated rating scales to maintain customer satisfaction and retention. Requestors may specify a delivery price they are willing to pay for their good or service to be delivered irrespective of the price a merchant offers the general public in addition to being able to offer premium pricing to personal shoppers to accept the order. This amount will have to be above a minimum pay which is calculated by the system parameters based on urgency and least cost routing to complete the task.

The present embodiment utilizes a process to restrict visibility of orders to only those currently available personal shoppers within a reasonable proximity to the event. Utilizing newsfeed functionality, an order will be presented to available personal shoppers. Preferred personal shoppers may be presented a preview in advance for a given time to accept on new order by a function embedded within the processes to delay distribution to other personal shoppers determined at the time the order is placed by the requestor.

There are several methods currently used today to locate a service provider using mobile applications, GPS, proximity mapping and web browsing, news feeds or other instant messaging networks. The present invention does not alter or disable this functionality and allow the requestor to utilize any such locating function which they may choose to use for their convenience.

The invention described herein automates consolidating and correlating information provided by the users, historical information recorded during prior events and exploratory information gathered from known public information regarding the setting and current events occurring in the general proximity of the instant circumstance. Such information will be available to drive incremental add-on sales, advertising, consolidation and other actions to improve through-put and economic viability for all users.

Still other objects of the present invention will become readily apparent to those skilled in this art from the following description wherein there is shown and described the embodiments of this invention, simply by way of illustration of the best modes suited to carry out the invention. As it will be realized, the invention is capable of other different embodiments and its several details are capable of modifications in various obvious aspects all without departing from the scope of the invention. Accordingly, the drawing and descriptions will be regarded as illustrative in nature and not as restrictive.

### BRIEF DESCRIPTION OF THE DRAWINGS

Various exemplary embodiments of this invention will be described in detail, wherein like reference numerals refer to identical or similar components, with reference to the following figures, wherein:

FIG. 1 is a flow diagram view of the preferred embodiment order process

FIG. 2A is screen shot of the profile display within an illustrative application

FIG. 2B is a screen shot of the now or later function within an illustrative application

FIG. 2C is a screen shot of the mapping function within an illustrative application

FIG. 2D is a screen shot of request function within an illustrative application

FIG. 2E is a screen shot of the delivery fee function within an illustrative application

FIG. 2F is a screen shot of the request now or request later function within an illustrative application

FIG. 2G is a screen shot of the order detail function within an illustrative application

FIG. 2H is a screen shot of the call now function within an illustrative application

FIG. 2I is a screen shot of the in-application messaging within an illustrative application

FIG. 2J is a screen shot of the rating system function within an illustrative application

FIG. 3 is a flow diagram view of preferred embodiment personal shopper engagement and driver suggestion process

FIG. 4 is a flow diagram view of the preferred embodiment rating process

FIG. 5 is a flow diagram view of the preferred embodiment payment process

FIG. 6 is a flow diagram view of the preferred embodiment individualized advertisement process

FIG. 7 is a flow diagram view of the preferred embodiment order consolidation process

### DETAILED DESCRIPTION

The claimed subject matter is now described with reference to the drawings. In the following description, for purposes of explanation, numerous specific details are set forth in order to provide a thorough understanding of the claimed subject matter. It may be evident; however, that the claimed subject matter may be practiced with or without any combination of these specific details, without departing from the spirit and scope of this invention and the claims.

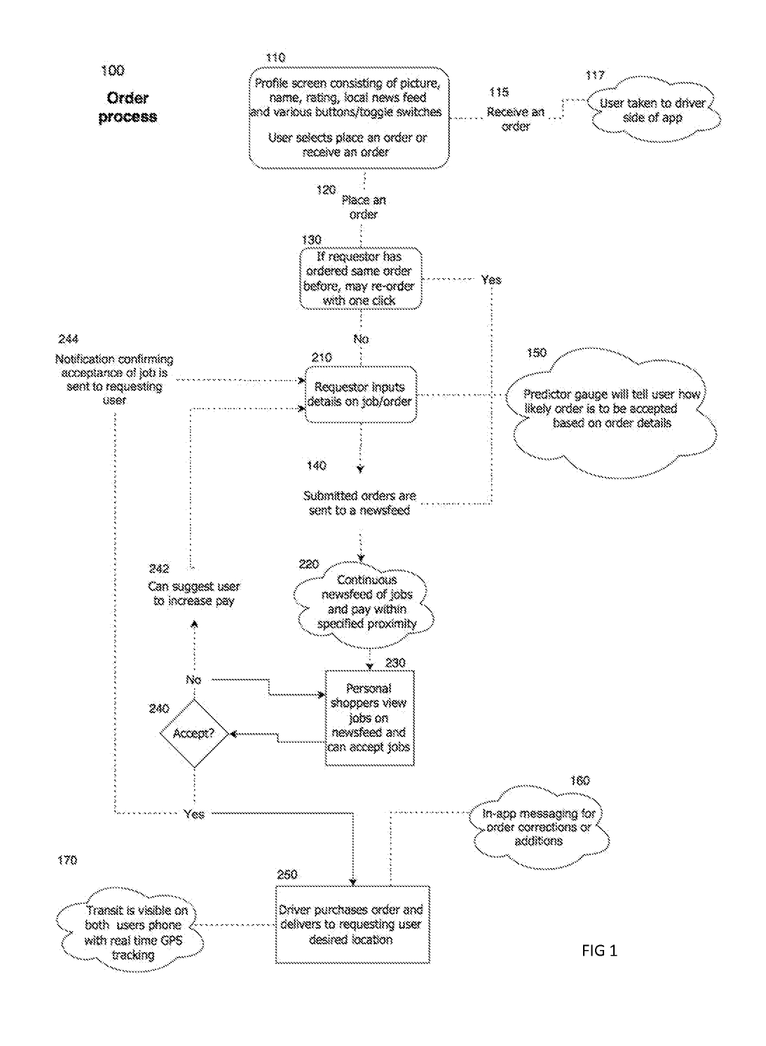

As shown in FIG. 1, the order process 100 provides profile 110 capture functionality through an application input screen prompt to input a picture of the user, user name, rating information, to display local newsfeeds and various toggle switches. The place order 120 function is an input provide by the user using the system. The order process 100 contains a subroutine 130 which functions to determine if the user has requested the same item previously, and if true, simplifies the order process by recalling the order with one-touch action.

With each first new order 120, details are input by the user on the job order 210. Once entered, the system distributes the order 120 to the newsfeed 140, The individual item newsfeed 140 feeds the collective newsfeed 220, Simultaneously, the system also distributes information contained in the order 210 to the predictor gauge routine 150, which analytically process information to determine estimates regarding likelihood of order completion and price to expect to be received from personal shoppers.

A personal shopper becomes active by initiating the system through the log on function within the system order process 100 in the profile 110 section within the process. Active personal shoppers receive 115 the job order 210 by the collective newsfeed 220 which is queued 230 as an option 240 for the personal shopper to select. Upon receiving a job order 210, the personal shopper is redirected to the personal shopper process 117. Within the personal shopper process 117, an affirmative action, acceptance 244, is processed by notifying the requestor that the personal shopper is agreeable to accepting the order 210. A rejection by the personal shopper is processed as an inquiry 242 returned to the requestor inviting the requestor to increase the offer fee entered by the requestor for the service in process 210. Acceptance and rejection are processed and presented to the requestor as an update to the job order 210.

Upon acceptance of job order 210 in acceptance 244, the personal shopper proceeds to perform 250 the job order. The requestor is provided additional functionality for change management 160 to provide the personal shopper additional instructions when applicable. The locator and tracking system 170 continuously collects information regarding the progress of the job order 210 and presents the location and tracking information to the requestor until the job order 210 is completed,

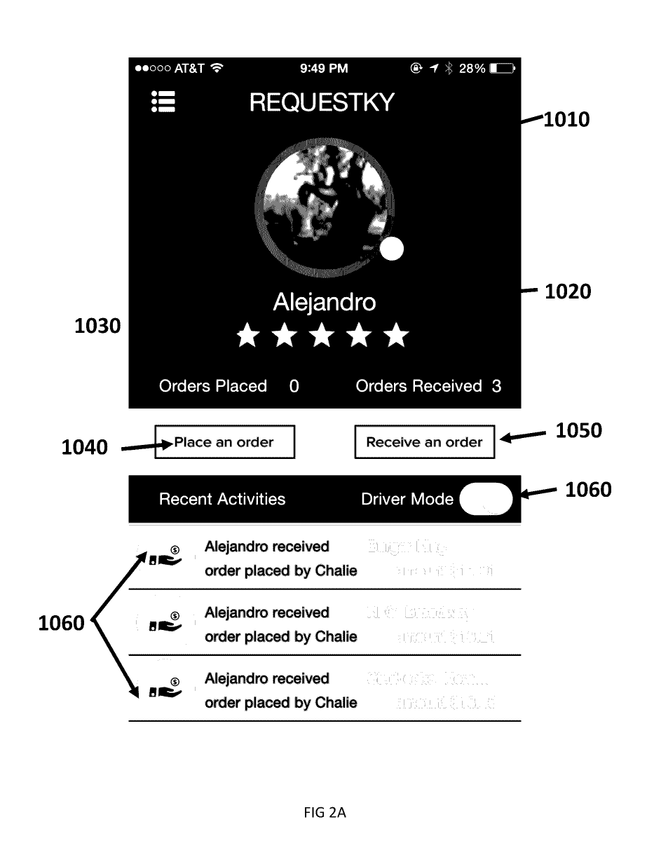

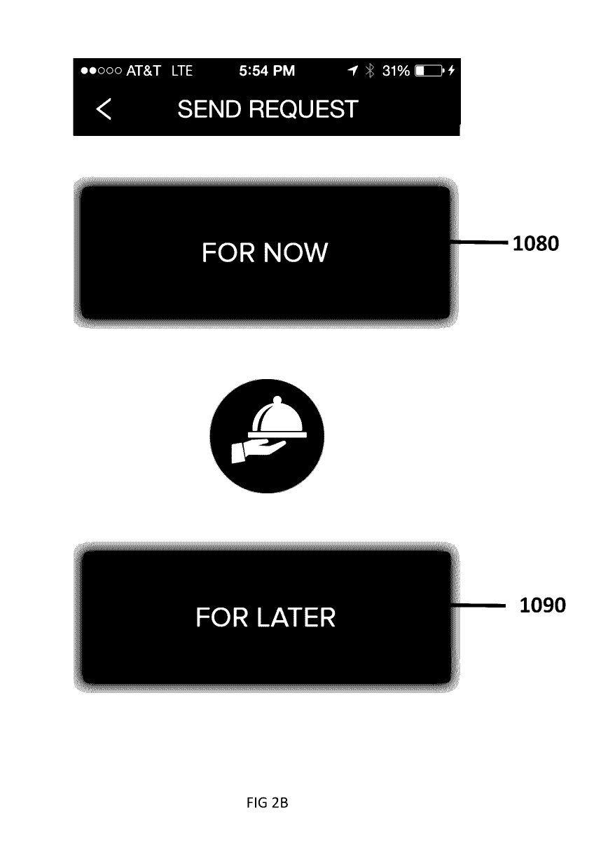

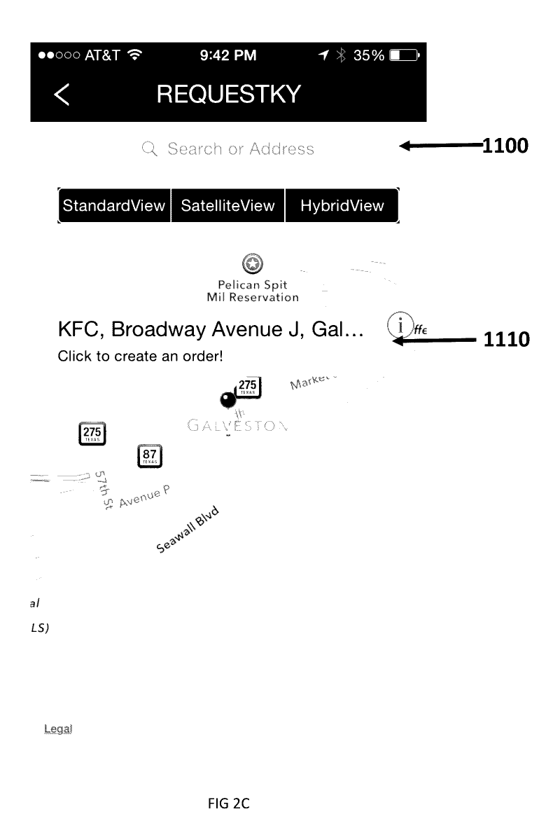

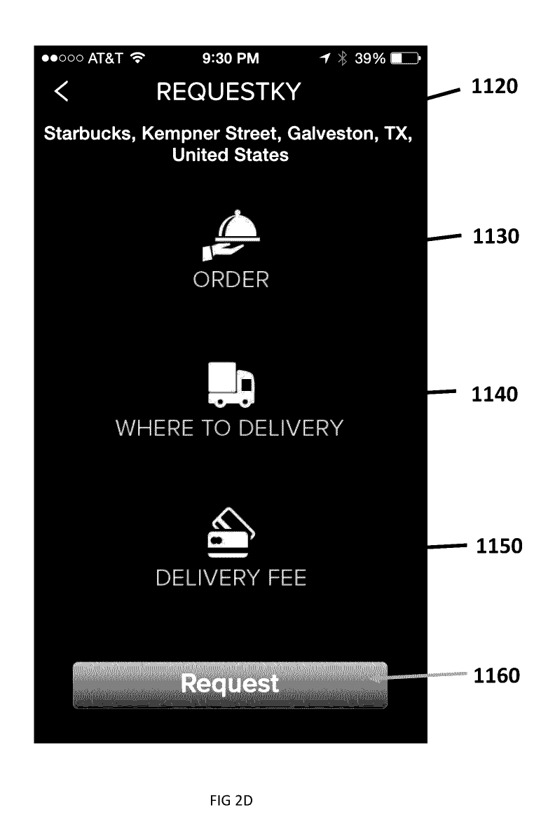

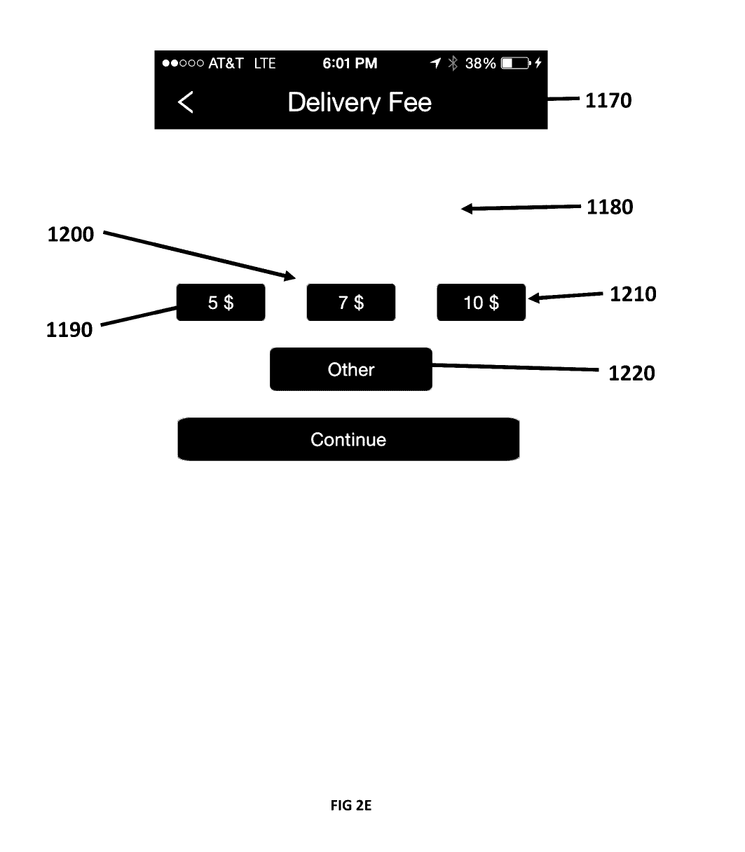

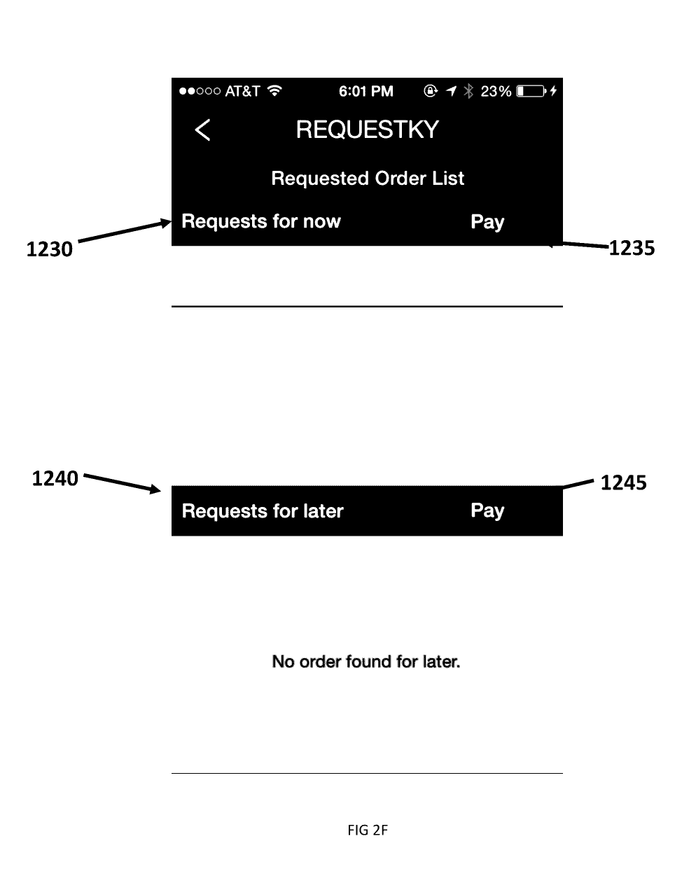

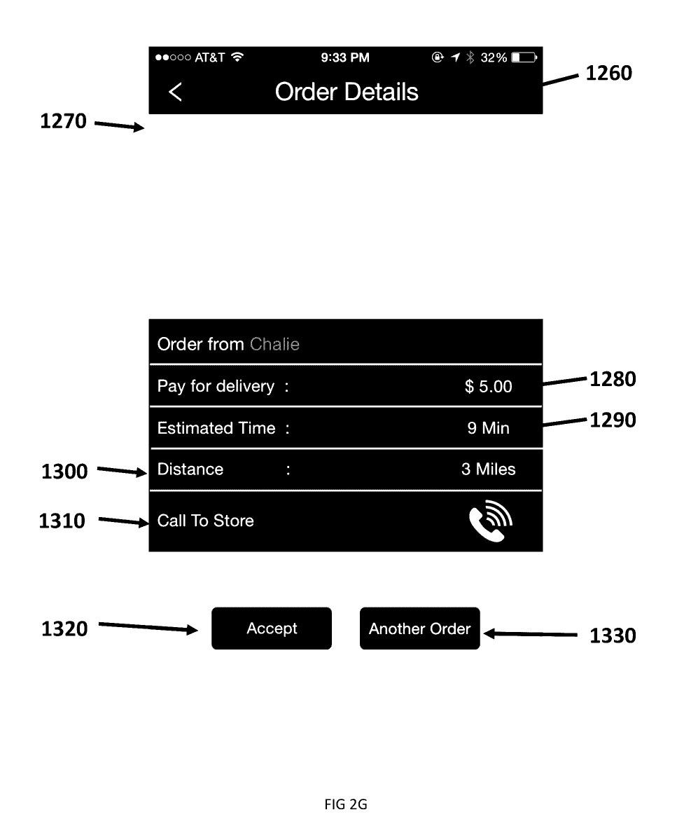

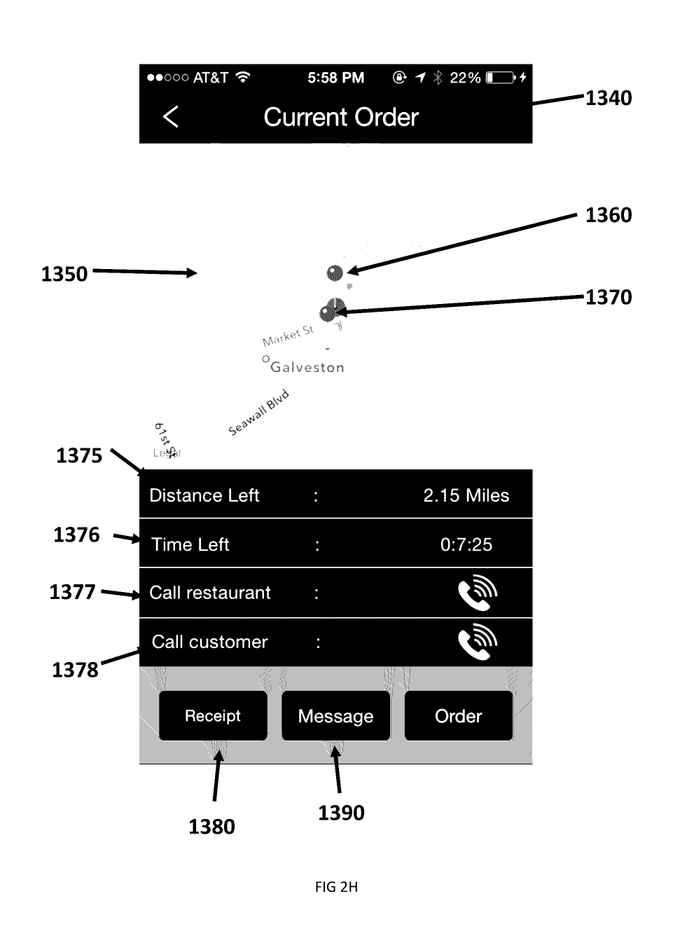

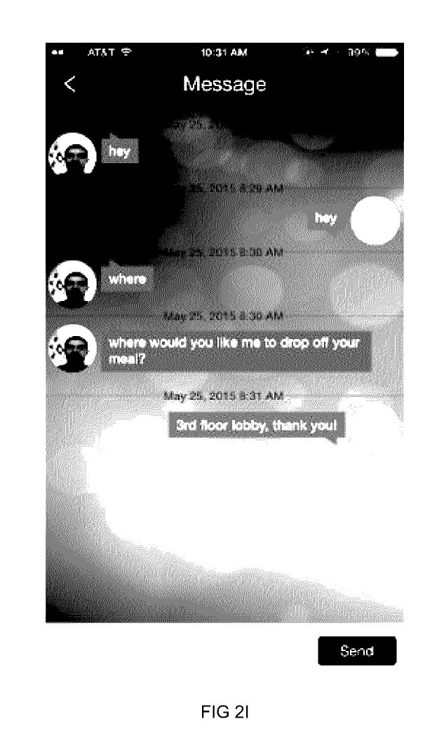

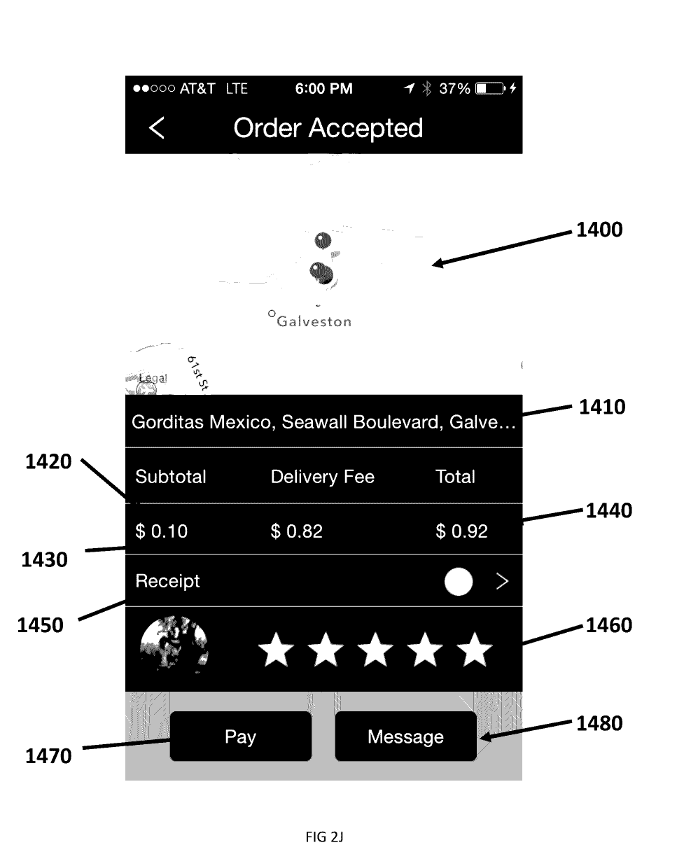

To illustrate the present embodiment, an application is shown in FIG. 2A through FIG. 2J. As shown in FIG. 2A, the present embodiment is represented as an application containing a series of interactive screen displays to the users. The first screen FIG. 2A after logging in is a profile page with the users profile picture 1010, name 1020, rating system 1030 and two buttons in the middle of the display (“Place an order” 1040 & “Receive an order” 1050) giving the user the option of sending out a request or receiving. There is also a toggle switch 1060 that ‘toggles’ a user to driver mode (in which he will receive notifications of request being submitted by other local users) or not on driver mode. The bottom of the screen will be a current newsfeed 1070 sharing local deliveries on what others are ordering around them.

By selecting “Place an order” FIG. 2A, 1040, the user will be sent to a screen FIG. 2B which will ask the user if they want the order “for now” 1080 or “for later” 1090. By selecting “Receive an order” FIG. 2A, 1050, system will activate the personal shopper interface FIG. 1, 117 of the system which will then proceed to system process 230, FIG. 1.

After this selection, a map interface is shown on the display which allows the user to search 1100 any place, restaurant, store, etc FIG. 2C. This will bring up the following information tab and the user will click the location 1110 to create an order 120, FIG. 1.

After clicking the location 1110 to create an order 120, FIG. 1, user will receive the display interface FIG. 2D as shown. At the top of the screen will be the current location 1120 that the request is being ordered from. Three buttons below this will be “order” 1130, “where to delivery”, 1140 and “delivery fee” 1150. Each button will bring up their respective input criteria by system process FIG. 1, 210. Next, the screen will display “order” 1130, and also open and display a text box to request the ‘list’/′order′ FIG. 2D 1060.

Next, “where to delivery” FIG. 2D 1040 will be displayed on another map which gives the user the option of selecting ‘current location’ or ‘another location’ and if the latter is chosen the user will need to input a delivery address which the system process shown in FIG. 1, 210 accepts as input.

Next, the screen FIG. 2E will display “delivery fee” 1170 which will bring up a blank 1180 that is auto-populated with a minimum delivery fee. This fee as illustrated is calculated with a formula using $0.75/mile, an amount which is not absolute, (using the distance from restaurant to drop off location). The preferred embodiment will also include process formula that considers variables such as: traffic, number of orders, and location of restaurant in the city which will be used in creating the minimum pay. Underneath this blank are 4 buttons for quick selection, “$5” 1190, “$7” 1200, “$10” 1210 and “other” 1220 button which the user can input another fee. User selections are process within the system as shown in FIG. 1, 210.

Only after all inputs, “order” 1130, “where to deliver” 1140 and “delivery fee” 1150 are input then the user can click “request” 1160 and the request will be sent to a database as 210, FIG. 1 and uploaded to a news feed FIG. 1, 140.

As shown in FIG. 1, 220 the requesting user will have a predictability gauge 150 which signifies to the user how likely and quickly his requested order will be accepted by a personal shopper FIG. 1, 150. The user can make changes to his order such as increasing pay, changing delivery location, etc. in process 160, FIG. 1.

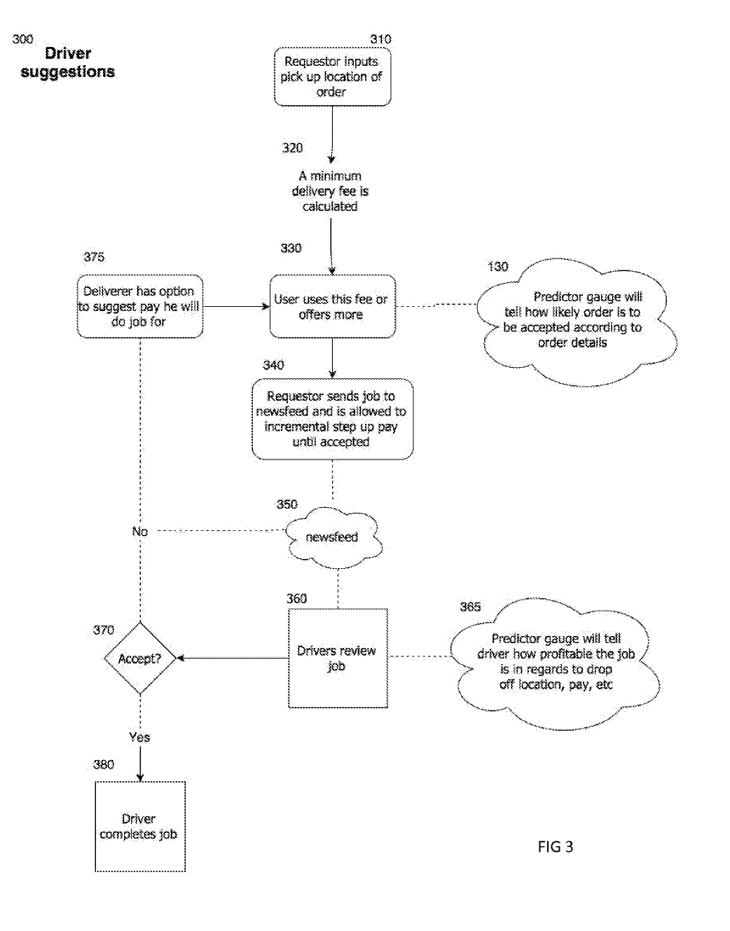

In FIG. 3, The Driver Suggestion process 300 is shown. The present embodiment is shown as a process wherein the personal shopper, also known as driver, receives notification 310 of a requestor's pick-up location associated with and order 210, FIG. 1. The system automatically calculates a minimum delivery fee 320 based on system parameters automatically calculated based on historical information, time of day, location and other such objective criteria.

The personal shopper may elect to accept the system generated fee 330 or may counter the proposed fee with an alternative fee. The system process known as the predictor gauge 130 will present an estimate as to the likelihood an order will be found to be acceptable to both parties under the proposed terms.

In process 340, shown in FIG. 3, the requestor's job order 210, FIG. 1, is published to the newsfeed 350. The requestor is able to incrementally increase the proposed fee term in the requestor's job order 201, FIG. 1 until the job order 210 is accepted by a personal shopper. Upon receiving a newsfeed containing a job order 210 with proposed delivery fee terms, a personal shopper may review the terms of the job order 210 in the review process 360, decide if the terms of the job order 210 are acceptable in process 370 and proceed to either suggest 375 a new delivery fee term or proceed to complete the order 380. To assist the personal shopper, the predictor gauge 365 will present to the personal shopper an estimate of job profitability based on the proposed terms of the job order 210.

In the preferred embodiment, illustrated as an application, personal shopper clearance is granted to potential drivers and with such clearance a personal shopper can click “receive an order” FIG. 2A, 1050 and it will connect the driver's device to this newsfeed. FIG. 3, 350. As new orders populate this newsfeed, a notification will be sent out to ‘drivers’ who have their driver mode toggled ‘on’ for each new job FIG. 1, 117. This newsfeed displays for now orders FIG. 2F, 1230 as well as for later 1240. The system also displays how much pay or delivery fee 1235 and 1245 respectively, the job is worth as well as the street the merchant is located, 1250. The personal shopper may make suggestions to the requesting user on changing job details FIG. 3, 375. When the driver selects the job in the newsfeed it will display more details on that job as shown in FIG. 2G, 1260.

It is another object of the present invention to provide the user a particular benefit of “selection” which is found in the present invention. This benefit is realized when the display shows the order list, FIG. 2G, 1270 that the user is requesting. It further displays the amount the requestor will be paying the personal shopper (“pay for delivery”) FIG. 2G, 1280, the estimated time 1290 for the round trip from driver's current location to restaurant and then drop off location, the miles coverage for round trip distance 1300 as well as the option to call the store 1310. The two buttons as shown for accepting that job 1320 or ‘another order’ 1330 which will revert the device to the newsfeed FIG. 3, 350. The personal shopper may choose to accept the job at this time FIG. 3, 370, return to the newsfeed 350 or make a suggestion for the user to increase the delivery pay FIG. 3, 375.

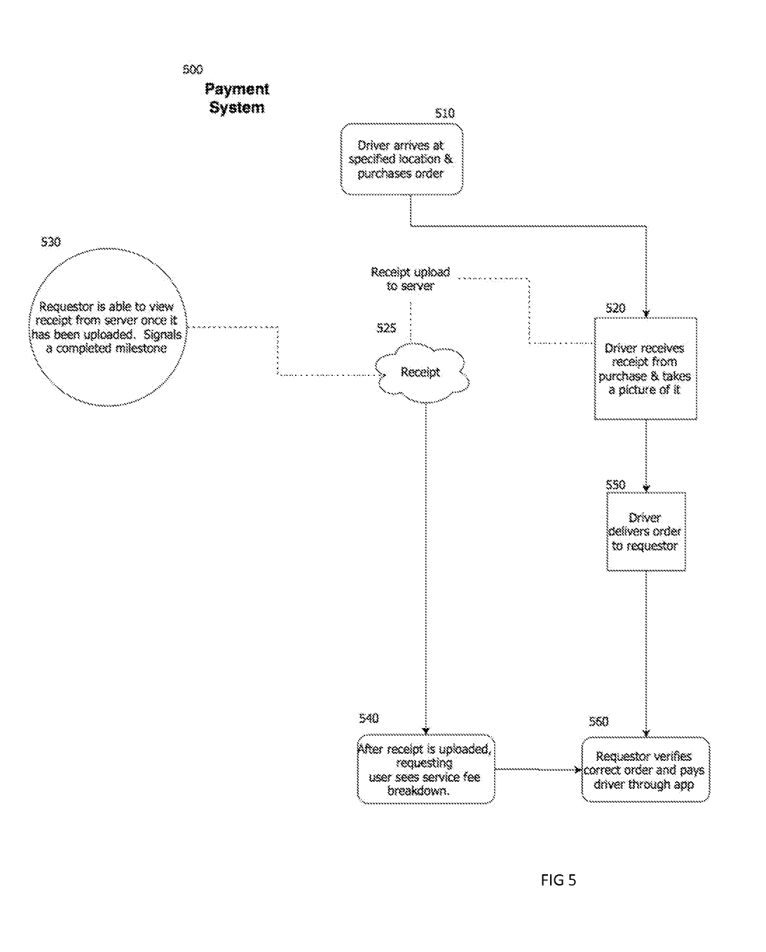

After accepting a job, a ‘current order’ FIG. 2H, 1340 display will come on the screen which shows a map 1350 with a point 1360 on the pick-up location of the merchant. A map will be displayed with real-time tracking 1370 of driver in transit to restaurant as well as drop off location FIG. 1, 170. Below this is a distance left in trip 1375, time left from estimated time of trip 1376, option to call the restaurant 1377, option to call the customer 1378 and two buttons (receipt 1380, message 1390). The receipt button 1380 takes the user to a new screen which he takes a picture of the meal receipt after he has purchased it as well as an input for the receipt total amount FIG. 5, 525. The message button 1390 brings up a chat forum for the requesting user and driver as presented FIG. 1, 160 and as shown in FIG. 2I.

In FIG. 5, the payment system is illustrated. The present embodiment provides enhanced interaction and quality control through a process whereby the personal shopper arrives at the merchant location FIG. 5, 510, acquires the goods or services, takes a picture of the receipt, FIG. 5, 520, which is then automatically uploaded FIG. 5, 525 to the requesting user view FIG. 5, 530. A notification is sent informing user receipt is uploaded FIG. 5, 530. The present embodiment illustrated in the form of an application is shown in FIG. 2J. This view has a map 1400 with tracking of goods in transit. Below this is information on the merchant 1410. Below this is the “subtotal” 1420 which is automatically uploaded when the receipt and total are filled in by the personal shopper, “delivery fee” 1430 which is the pay the requesting user proposed at the beginning and total 1440 which is reflect in process shown in FIG. 5, 540. Below this is the receipt link 1450 which once selected directs the user to a view with the picture of the receipt. The personal shopper proceeds to deliver the goods or services to the requestor, FIG. 5, 550. A rating system FIG. 2J, 1460 is below this which can be filled out. Two buttons are beneath which show “pay” 1470 and “message” 1480. Pay 1470—a notification is brought for confirmation of payment which is achieved after confirmation through Paypal® FIG. 5, 560 and debit/credit card information which is previously stored. Message 1480 brings up the messaging forum as shown previously FIG. 1, 160.

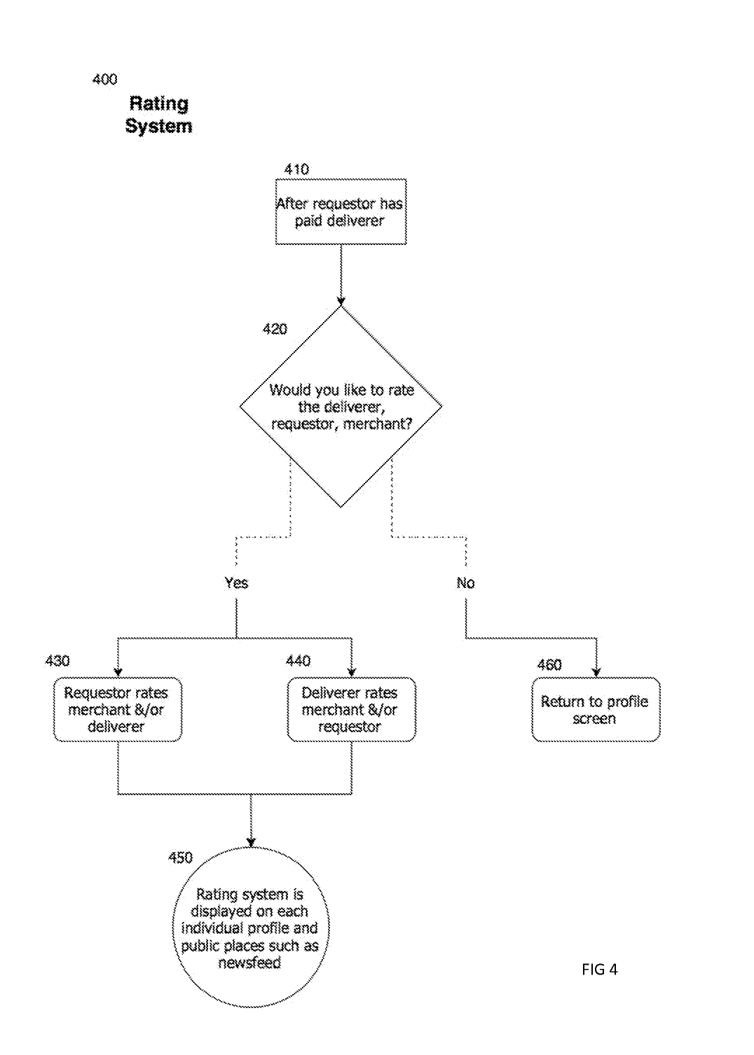

After paying, the system will take the requestkying user to the profile page. The personal shopper user and requesting user will be sent to a rating page inquiry to rate the requesting user FIG. 4, 420.

In FIG. 4, the rating system 400 is illustrated. Once the personal shopper completes the job order FIG. 1, 210, and receives payment FIG. 4, 410, the system prompts the requestor to rate the personal shopper and/or the merchant 420. If the requestor declines to rate either, the system defaults to the profile screen 460. If the requestor elects to rates either the personal shopper, the merchant or both 430, the rating system 450 is displayed.

A mirror rating process 400 is also presented to the personal shopper to rate either the requestor, the merchant or both. As shown in FIG. 4, 440, the personal shopper electing to rate the requestor or merchant or both is shown, the rating then is presented and displayed as shown in 450.

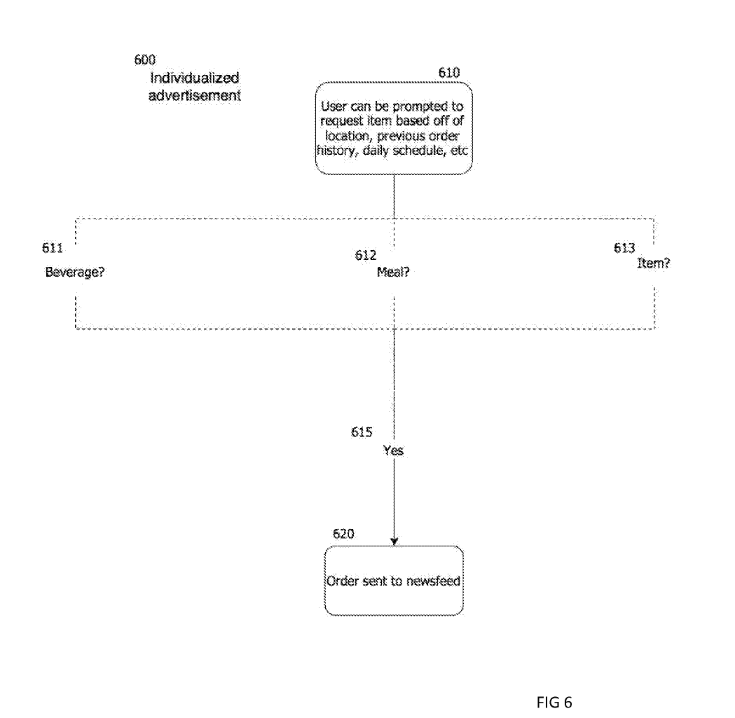

The present embodiment also includes functionality to increase attraction, participation and retention of merchants to participate proactively in using the system by adding features to advertise to customers and personal shoppers. In the individualize advertisement process shown in FIG. 6, 600, when a requestor initiates a job order FIG. 1, 210, the system can prompt the requestor 610 for additional items, promote current specials, or display other information about the merchant which could be relevant to the job order 210. For example, an accompanying beverage 611, meal 612, or other item 613 can be presented to the requestor along with a acceptance 615 response. Once the requestor accepts or rejects the offer in process 615, the job order FIG. 1, 210, is sent to the newsfeed 610.

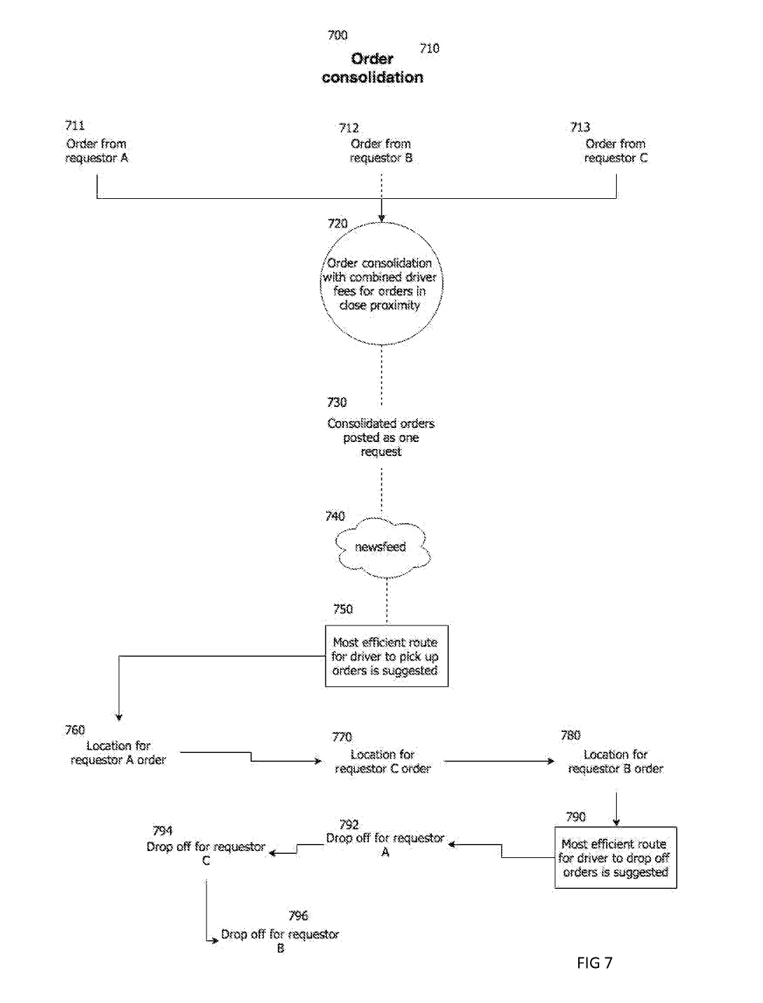

In FIG. 7, the order consolidation process 700 is shown. The system provides simultaneous capture of multiple orders from various requestors. A job order FIG. 1, 210 from requestor “A” is shown as 711; requestor “B” as 712; and requestor “C” as 713. The number of simultaneous job orders 210 is not limited.

Based on factors such as location, merchant location or item type, the system functionality will consolidate job orders 210 according to the process 720 to be posted 730 to the newsfeed 740. Additionally, the system will apply least cost routing techniques to sequence the pick-up and delivery of the job orders 210 according to the processes 750 and 790. The job order sequence is illustrated as step 760, 770 and 780 respectively. Based on factors such as location, shelf life of ideal temperature, time of day specifications provided by the requestor and other details communicated to the personal shopper from the requestor FIG. 1, 160, the system will prompt the personal shopper with the suggested route and sequence for delivery as step 792, 794 and 796 respectively.

An additional function of the system is to provide merchant incremental opportunity to present advertisement to both personal shoppers and requestors. A merchant may elect to include a conditional offer to accompany the fulfillment at the time of delivery based on conditions observed by the personal shopper. Such advertisement may be presented in the form of an incentive to the personal shopper, a coupon presented to the requestor, or coupons presented to other third parties at the same location as the requestor when the goods or services are delivered. The merchant may specify conditions that must be met prior to presentation of the conditional advertisement. For example, a merchant may incentivize the personal shopper to present a coupon for twenty percent off the next order by the same requestor if three or more people are present at the delivery location.

It may be advantageous to set forth definitions of certain words and phrases used in this patent document. The term “couple” and its derivatives refer to any direct or indirect communication between two or more elements, whether or not those elements are in physical contact with one another. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

What has been described above includes examples of the claimed subject matter. It is, of course, not possible to describe every conceivable combination of components or methodologies for purposes of describing the claimed subject matter, but one of ordinary skill in the art can recognize that many further combinations and permutations of such matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

We claim:

1. Method for providing personal shopping services consisting of:
a mobile communication device equipped capable of running a local application installed on the device; a local application; processor and memory to execute the local application; connectivity to a wireless network suitable for voice and data communications;
a network application server;
a subscription held by the user to the service;
authentication of valid payment account which to transact payment for goods and services;
a database of users with profiles stored in device and remote network locations;
a database of merchandise and services offered for sale by merchants stored in device and remote network locations;
an interactive link connecting the local application to various social media accounts held by the subscriber;
analytical capabilities to optimize point-to-multipoint tasks;
newsfeeds to stream tasks to users;
location determination, reporting and mapping capability; and,
subscriber specified service level commitments.

2. The method in claim 1, consisting of:
process for individuals will be paying another one for completed tasks;
a task order containing a list of items to purchase to be transmitted to a personal shopper through the networking between the local application running on the respective mobile devices of the subscribers and the application server;
an in-app messaging feature enabling users to communicate directly with each other regarding edits, deletes and additions to task orders in real time;
a one-touch reorder option;
a scheduler routine to organize and track tasks associated with single subscriber profiles;
anonymous social media associations based on common preferences between subscribers within proximity to others with history for placing similar task orders;

3. The method in claim 1, consisting of:
time-in-motion scheduling of task orders communicated to merchants and personal shoppers based on service level commitments specified;
task orders posted in newsfeeds visible to and accepted by the personal shoppers;
positive feedback to subscriber of a task order acceptance by a personal shopper;
GPS tracking and reporting the transit of the acquired goods which will be continuously updated;
Real time on-demand feature to provide additional instructions to the personal shopper for task order modification;
selection criteria to limit visibility of pending task orders to personal shoppers within proximity based on current location to the subscriber and merchant to complete task order within service level specifications provided;

4. The method in claim 1, consisting of:
A least cost routing calculator that estimates the time-in-motion to complete the task and provide a suggested fee to the subscriber for the completion of the task;
Subscriber option to add a premium as an incentive to personal shoppers to accept the task order and associated service level commitment for the task order submitted;
A process to publish the suggested task order fee plus an incremental step in the premium until the task order is accepted or the premium maximum is reached;
and,
A reverse auction feature which allows personal shoppers to offer lower fees than the suggested fee calculated to accept task orders when more than one personal shopper is available to accept the task order.

5. The method in claim 1, consisting of:
A process wherein the subscriber can rate the performance of the merchant;
A process wherein the subscriber can rate the performance of the personal shopper;
A process wherein the personal shopper can rate the merchant;
A process wherein the personal shopper can rate the subscriber; and,
A rating system display process for subscriber and personal shoppers through the local application.

6. The method in claim 1 for providing personal shopping services where in subscribers are prompted automatically to add tasks to an activity list currently being processed for third parties as a result of a subscriber's prior experience and the current location of users and their proximity to merchant locations.

7. The method in claim 1 for providing personal shopping services where tasks originated by independent subscribers are consolidated to form a point-to-multipoint task order which is determined using least cost routing techniques for route planning and time duration of incremental tasks to remain within service level agreement specifications.

8. The method for providing personal shopping service wherein when personal shopper (driver) arrives at the store to purchase the wanted items, the merchant is in the position to make a conditional promotional offer for the personal shopper to present to the consumer at the time goods and services are delivered by the personal shopper to the requesting consumer subject to the prerequisite conditions being satisfied.

9. The method for providing personal shopping services wherein a photograph of a receipt for goods purchased and the goods purchased as reflected on the receipt are captured, stored in memory and transmitted to the subscriber as authentication of a task milestone completion.
